(19) United States
(12) Patent Application Publication
(10) Pub. No.: US 2006/0275602 A1
(43) Pub. Date: Dec. 7, 2006

(54) Releasable adhesive tape

(76) Inventors: Yoichi Nakada, Segamihara-city, Kanagawa (JP); Eiji Mizuno, Kanagawa (JP); Hideki Ryu, Kanagawa (JP)

Correspondence Address: 3M INNOVATIVE PROPERTIES COMPANY, PO BOX 33427, ST. PAUL, MN, 55133-3427, US

(21) Appl. No.: 10/571,042

(22) PCT Filed: Sep. 2, 2004
(86) PCT No.: PCT/US04/28617

§ 371 Date: Mar. 3, 2006

(30) Foreign Application Priority Data
Sep. 5, 2003 (JP) 2003-314221

(51) Int. Cl. B32B 7/12

(52) U.S. Cl. 428/343

(57) ABSTRACT

A releasable adhesive tape comprising an extensible substrate layer and a pressure sensitive adhesive layer held on at least one surface of said substrate layer, wherein one end portion is divided parallel to the longitudinal direction of the tape.

### FIELD

The present invention relates to a releasable adhesive tape that can be removed from an adherend by pulling along the bonding plane, and more particularly to an improvement of such a releasable adhesive tape.

### BACKGROUND

Releasable adhesive tapes can be broadly divided into two known types. One type of releasable adhesive tapes uses special adhesive, and the other type uses special substrate layer (that is, a special substrate material for supporting adhesive).

A releasable adhesive tape of latter type can be removed from an adherend simply by pulling it in the shear direction along the bond plane. Thus, this type of releasable adhesive tape is also called as an extensible releasable adhesive tape. This type of adhesive tape comprises an extensible substrate layer, and a pressure sensitive adhesive layer which is provided on this substrate layer and which usually exhibits relatively high adhesive strength.

FIG. 1 is a side sectional view of a releasable adhesive tape in prior art showing the manner of stretching off the extensible releasable type adhesive tape adhered to an adherend. FIG. 1(a) shows initial stage and FIG. 1(b) shows final stage of the removal operation. The releasable adhesive tape 1 comprises a pressure sensitive adhesive layer 3 provided on a substrate layer 2, and is adhered to an adherend 5 (for example, a wall surface) via the adhesive layer 3. As shown in FIG. 1(a), when a pulling tab 4 of the releasable adhesive tape 1 is pulled to stretch the tape 1, a moderate shearing force (F1) is exerted to the adherend 5 so as to induce separation in the interface between the adhesive layer 3 of the adhesive tape 1 and the adherend 5. As shown in FIG. 1(b), at the final stage of the removal operation, surface of the adhesive layer on the adherend 5 has become so small in area that, although the adhesive tape is pulled in the direction parallel to the surface of the adherend 5, a tension (F2) is produced in the direction perpendicular to the surface of the adherend. Thus, when a large tension is exerted to the adherend at the final stage of the pulling operation, so-called “surface peeling” may occur in which the adherend is peeled off in the bonding surface, thereby damaging the surface.

Therefore, there exists a need for a releasable adhesive tape which is capable of preventing the damage of an adherend due to the surface peeling without compromising the adhesive strength of the adhesive tape when adhered to an adherend. At present, there is no adhesive tape which can completely satisfy this requirement. A releasable adhesive tape is disclosed in patent references 1 and 2 which has the width gradually decreased toward the end portion thereof, although this is not intended to prevent damage of an adherend. Such a releasable adhesive tape is intended to prevent the damage of the substrate layer in the final stage of the removal operation which may give rise to residual adhesive layer left on an adherend. Although such an adhesive tape may be capable of avoiding damage of the substrate layer and thereby preventing residual adhesive layer from being left on the adherend, it is difficult to ensure sufficient adhesion area as an adhesive tape since its width gradually decreases toward the end portion. Thus, adhesion performance of the adhesive tape is inevitably degraded.

### SUMMARY OF THE INVENTION

Therefore, the present invention provides a releasable adhesive tape which exhibits sufficient adhesive performance during usage and which is capable of preventing the adherend from being damaged by peeling.

The present invention solves the above-described problem by providing a releasable adhesive tape comprising an extensible substrate layer and a pressure sensitive adhesive layer held on at least one surface of said substrate layer, wherein an end portion is divided in the longitudinal direction.

In such an adhesive tape, by dividing the end portion in the longitudinal direction, the tension exerted in the direction perpendicular to the surface of the adherend during the final stage of the removal operation can be reduced and damage of the adherend can be thereby prevented. Since only the end portion is divided in the longitudinal direction, sufficient area for adhesion surface can be ensured so that the high adhesive performance of the adhesive tape is not paired.

The releasable adhesive tape of the present invention exhibits adequate adhesive capability during usage, and permits removal from the adherend without giving rise to damage to the adherend after usage.

### BRIEF DESCRIPTION OF THE DRAWINGS

FIGS. 1a and 1b are side sectional views showing the stretch removal of a releasable adhesive tape adhered to an adherend;

FIG. 2a is a schematic representation showing a releasable adhesive tape according to the present invention;

FIG. 2b is a side sectional view of the releasable adhesive tape of FIG. 2a.

FIG. 3 is a schematic view showing the final stage of peeling when the releasable adhesive tape according to the present invention is stretched;

FIGS. 4a-e are plan views showing several aspects of the releasable adhesive tape according to the present invention;

FIGS. 4a′-e′ are side views of the releasable adhesive tapes of FIGS. 4a-e.

FIGS. 5a-c are schematic views showing several aspects of the releasable adhesive tape according to the present invention;

### DETAILED DESCRIPTION

The present invention will now be described in detail with reference to drawings showing preferred embodiments thereof. It will be easily understood by those skilled in the art that the present invention is not limited to these embodiments. In the drawings, same or similar parts are denoted by same reference numerals.

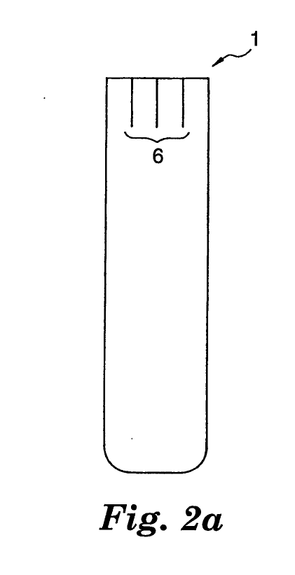

FIG. 2 is a schematic illustration showing a releasable single-coated adhesive tape (hereinafter referred to simply as “adhesive tape”) according to the present invention. FIG. 2(a) is a top plan view, and FIG. 2(b) is a sectional view showing the longitudinal section of the tape. The releasable adhesive tape 1 comprises a substrate layer 2 and a pressure sensitive adhesive layer 3 which is provided on one surface of the substrate layer and which usually exhibits relatively high adhesive strength. The releasable adhesive tape 1 is an extensible releasable type adhesive tape which loses its adhesive strength to the adherend 5 when it is stretched by pulling the pulling tab 4 and is removed from the adherend 5. In the present invention, there is provided, at an end portion opposite to the pulling tab 4, a region 6 in which the tape is divided in the longitudinal direction of the tape. Since the releasable adhesive tape 1 of the invention is removed by stretching of the tape upon pulling, the substrate layer 2 is generally formed of an extensible material. The substrate layer 2 is preferably, but not limited to, plastically extensible. If the substrate layer is made of material capable of being deformed elastically such as rubber, it may elastically rebound to original length upon completion of peeling so that it may strike at human body such as hands and may thus give rise to some danger. Thus, according to the present invention, such a plastically extensible substrate layer includes a highly extensible polymer sheet material, and more specifically, has (1) a high tensile strength, (2) an elongation at breaking point in the longitudinal direction of the releasable pressure sensitive adhesive tape of 50˜1200%, preferably 150˜700%, and more preferably 350˜700%, (3) a substantial non-elasticity with elastic recovery of less than about 50%, preferably less than about 30%, and more preferably less than about 20% after elongation, 15 and (4) Young's modulus of which the lower bound is at least about 2500 psi (17.2 MPa), preferably at least about 3000 psi (20.7 MPa), and upper bound is less than about 72500 psi (500 MPa), preferably less than about 50000 psi (345 MPa), and more preferably in the range of about 5000˜ about 30000 psi (34.5˜207 MPa).

If a polymer sheet material having too low Young's modulus is used, the substrate layer would lose plasticity and would become rubber-like. It is also necessary that the substrate layer should have sufficiently high tensile strength and should not be destructed before the releasable pressure sensitive adhesive tape has been removed from the bonded surface. Therefore, tensile strength of the substrate layer is preferably at least about 4000 psi (27.6 MPa), more preferably at least about 5300 psi (36.5 MPa), and most preferably at least about 6300 psi (43.4 MPa).

In accordance with the present invention, examples of typical material that can be suitably used for this substrate layer include polyethylene, high density polyethylene, low density polyethylene, linear low density polyethylene, linear ultra-low density polyethylene, polyolefin such as polypropylene and/or polybutylene, olefin copolymer such as polyvinyl chloride with or without a plasticizer and/or polyvinyl acetate, vinyl copolymer such as ethylene/methacrylate copolymer, ethylene/vinyl acetate copolymer, acrylonitrile-butadiene-styrene copolymer, ethylene-propylene copolymer, acryl polymer and copolymer, and mixtures thereof.

For example, all plastics such as polypropylene/polyethylene, polyurethane/polyolefin, polyurethane/polycarbonate, polyurethane/polyester, and plastic (ductile) material and elastic material may be used.

The substrate layer may be a single layer or multi-layer film, non-woven film, porous film, foam film or a combination thereof. For example, the substrate layer may be composed of several separate layers, a laminate of elastic material and plastic material, or may be formed of alternately laminated elastic material and plastic material, as long as it exhibits good overall elongation not less than 100% and low elastic recovery of less than 50%. An adhesive such as a pressure sensitive adhesive may be provided between these layers as required. The substrate layer may also be formed of filled material such as a film containing a filler, for example, polyolefin filled with calcium carbonate. The substrate layer is preferably formed of material selected from polyethylene and polypropylene film, and most preferably of linear low density polypropylene film or ultra low density polyethylene film.

The substrate layer may be manufactured using any known film forming method, such as extrusion method, simultaneous extrusion method, solvent injection molding method, non-woven fiber method. The substrate layer may have any thickness as long as it permits processing and handling to be carried out, and preferably has thickness in the range of about 10 micrometers (μm)˜250 micrometers. If the substrate has thickness less than 10 μm, it is undesirable to be used with an aggressive adhesive. If the substrate has thickness greater than 250 μm, an unnecessarily large pulling force tends to be required for removal from the adherend, and removal of adhesive tape may become difficult. In the preferred range of thickness as described above, a thin substrate layer tends to be removed more easily than a thick substrate layer.

As shown in FIG. 2(b), a pressure sensitive adhesive layer 3 (hereinafter referred to simply as “adhesive layer”) is disposed on the substrate layer 2.

The adhesive layer 3 may comprise a pressure sensitive adhesive of any adhesive strength, specific adhesion characteristics being dependent upon particular applications of the releasable pressure sensitive adhesive tape of the present invention. Preferable adhesion characteristics are in the range of about 13 N/dm to about 200 N/dm, preferably about 25 N/dm to about 100 N/dm when measured in accordance with ASTM D 903-83 and PSTC-1 and PSTC-3 at the peeling angle of 180° and at peeling velocity of 12.7 cm/min. In order for the adhesive to have higher level of peeling adhesive strength, a substrate layer having higher tensile strength is usually required.

Suitable pressure sensitive adhesives that can be used with the present invention include rubber adhesives containing a tackifying additive such as natural rubber, olefin, silicone, polyisoprene, polybutadiene, polyurethane, styrene-isoprene-styrene and styrene-butadiene-styrene block copolymers, and other elastomers, and acryl adhesives with and without tackifying additives such as copolymer of isooctylacrylate and acrylic acid. These pressure sensitive adhesives can be polymerized using various methods such as irradiation method, solution method, suspension method or emulsion method. Preferably, a cross-linking type adhesive, especially a cross-linking type pressure sensitive adhesive that provides a high shear strength, is used. The most preferable adhesive is an adhesive that becomes cross-linking upon energy irradiation with or without chemical cross-inking agent. An adhesive having high shear strength provides a low debonding force, and can be easily removed when pulled and stretched.

Thickness of the adhesive layer may be in the range of about 25 μm to about 1000 μm, preferably about 50 μm to about 400 μm. In the preferred range of thickness, the thicker the adhesive layer is, the more easily the releasable pressure sensitive adhesive tape tends to be removed by pulling at low angles. Since it has been known that, in general, the debonding force of a pressure sensitive adhesive tape as measured with typical removal procedure, for example at peeling angle of 90° or greater (for example, 180° debonding force) tends to become large with increasing thickness of the adhesive layer, the above-described tendency for removal of a releasable adhesive tape is in clear contrast to the case of removal of ordinary adhesive tapes.

Without being bound by any theory, the tendency that the debonding force of a releasable pressure sensitive adhesive tape becomes higher as the thickness of the adhesive layer becomes small, can be explained as follows. When a releasable pressure sensitive adhesive tape is advantageously removed by pulling at a low angle of less than 35° relative to the bonding surface, the adhesive layer tends to be confined by the substrate layer and the adherend in the case of single-coated adhesive tape, or by the substrate layer and two adherends in the case of double-coated adhesive tape, so that it is unavoidably subjected to a significant elongation. Under these conditions, the adhesive layer (or each adhesive layer) is forced to shrink, and the cross-sectional area (that is, area of the section perpendicular to the bonding surface) decreases. The cross-sectional area of a thin adhesive layer, that is, the product of the thickness and the width of the adhesive layer is already smaller than that of a thick adhesive layer. Therefore, when the adhesive tape is pulled by a given force, stress exerted to the above-mentioned section (tensile stress), that is, the force per unit area, is higher for the thin adhesive layer than for the thick adhesive layer. Thus, in the case of a thin adhesive layer, hardening proceeds at higher level compared to a thick adhesive layer, and the resistance to deformation becomes higher. For this reason, the force required for peeling is thought to become higher with decreasing thickness of the adhesive layer.

According to the present invention, as shown in FIG. 2, the releasable pressure sensitive adhesive tape 1 is provided with a region 6 that is divided along longitudinal direction, that is, along the extending direction of the adhesive tape (for example, slits) at an end portion opposite to the pulling tab 4. The number of divided areas may be 2 or more, and thus, one or more slits exist at this end portion of the adhesive tape. Slits are advantageously provided so as to divide the adhesive tape evenly in the width direction. It has been confirmed that, by forming a divided region 6 in this manner, when the adhesive tape of the present invention is removed from adherend after it was applied to wall body having on its surface a wall paper made of a resin of relatively low strength such as polyvinyl chloride foam, paper, fiber or the like, damages to the wall surface due to surface peeling, etc., do not occur.

Without being bound to any particular theory, a possible mechanism for the prevention of damage to an adherend as described above in accordance with the present invention may be explained as follows.

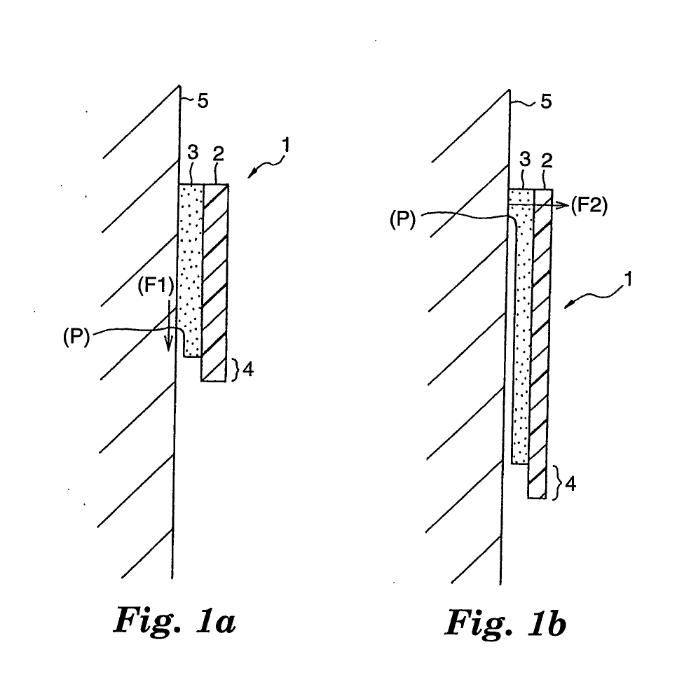

The releasable adhesive tape can be advantageously removed by pulling it at low angle of less than 35° relative to the bonding surface. This is explained below with reference to FIG. 1(a) showing a releasable adhesive tape. When the pulling tab 4 is pulled downward in the Figure, a shear stress is produced in the interface between the adhesive layer 3 and the adherend 5. This shear stress becomes maximum in the lowermost region of the adhesive layer 3, where peeling starts. In FIG. 1(a), the shear stress is concentrated to the location of peeling (peeling line: P). At some time point when the adhesive layer is peeled off at the peeling line (P), the shear stress is released and the peeling line (P) is propagated upward for removal. At the final stage of removal, as shown in FIG. 1(b), the peeling line (P) has moved to the end portion opposite to the pulling tab 4. Although the adhesive tape 1 is pulled at a low angle relative to the bonding surface, there exists a component of force in the direction perpendicular to the surface of the adherend 5. At the final stage of removal as shown in FIG. 1(b), area of the bonding surface becomes so small that the force per unit surface area of the adherend 5 (that is, tensile stress) becomes very high, which may give rise to damages due to surface peeling of the adherend 5. In the present invention, however, by providing a divided region 6 at the end portion of the adhesive tape 1 as shown in FIG. 2, the stress at the final stage of removal can be distributed to several regions (hatched regions). It is considered that the damages to the adherend can be prevented by thus distributing the stress over several regions.

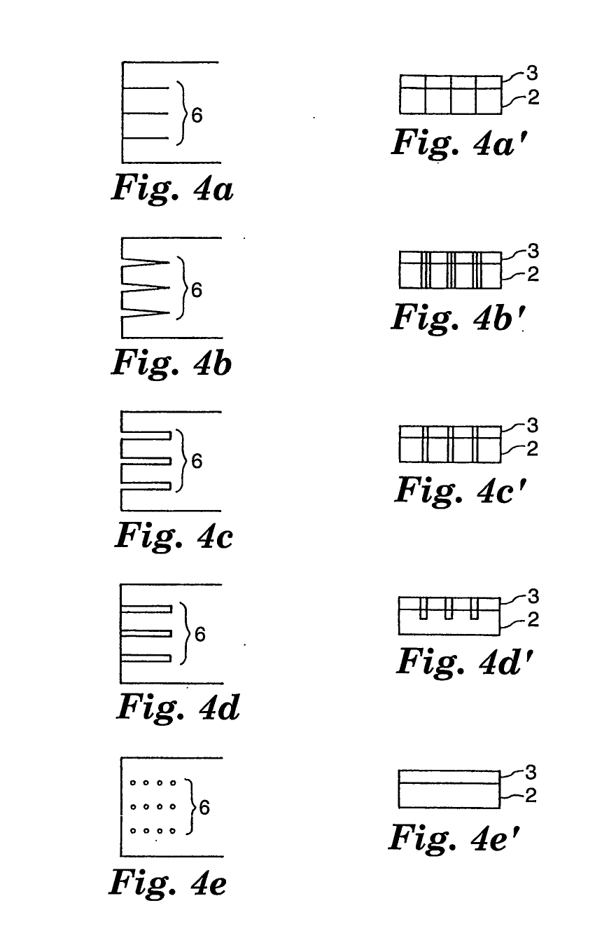

Possible forms of the divided region 6 include, but are not limited to, a form consisting of slits formed by cutting in the longitudinal direction of the adhesive tape 1 using suitable means such as a knife, at the end portion of the adhesive tape 1. In FIGS. 4(a)˜(e) and (a′)˜(e′), various possible forms of the divided region that can be used in the present invention are shown. FIGS. 4(a)˜(e) are bottom views of the tape in respective cases. FIGS. 4(a′)˜(e′) are side views of the divided region as seen from the side of the end portion of the tape in the cases of FIGS. 4(a)˜(e), respectively. FIG. 4(a) shows a case where slits are used for division, FIG. 4(b) is a case where notches are used for dividing the region, FIG. 4(c) is a case where slots are provided to divide the region, FIG. 4(d) is a case where grooves are provided to divide the region, and FIG. 4(e) is a case where a sequence of perforations are provided for division.

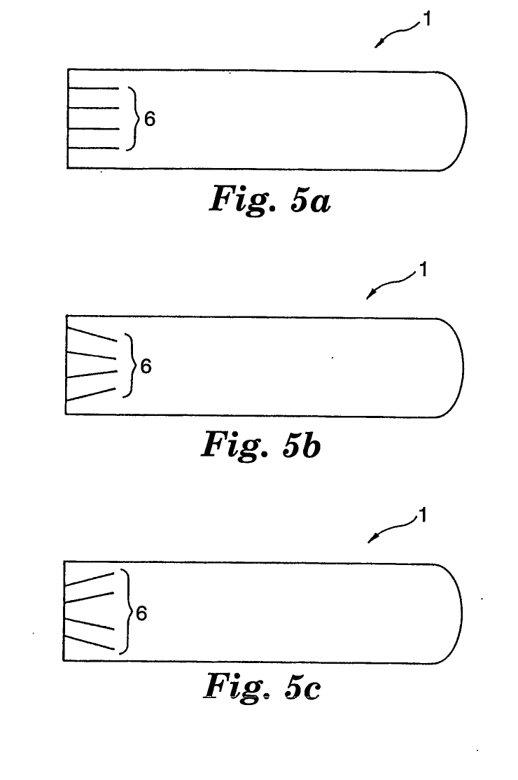

Further, FIGS. 5(a)˜(c) show adhesive tapes according to several aspects of the present invention. As shown in these Figures, the end portion need only to be divided in the longitudinal direction of the tape. The tape may be divided approximately in parallel to the longitudinal direction of the tape as shown in FIG. 5(a), or may be divided not in parallel to the longitudinal direction of the tape as shown in FIGS. 5(b) and (c).

Length of the divided region is not particularly limited as long as the object and effect of the present invention can be attained, and is typically 1.5 to 20.0 mm, preferably 1.5 to 10 mm, and more preferably 2.0 to 7.0 mm.

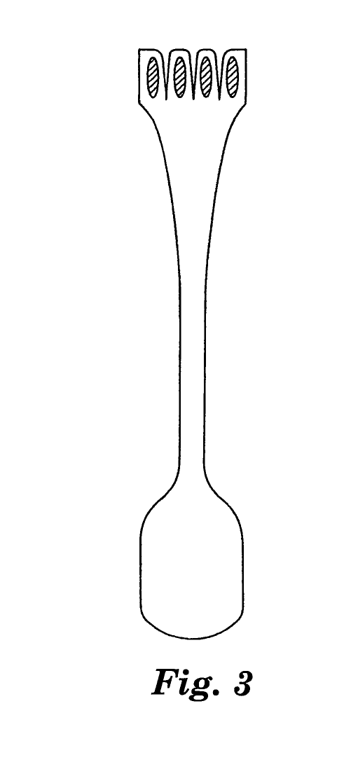

The releasable pressure sensitive adhesive tapes as shown in FIGS. 2 and 3 have substantially the same width in the longitudinal direction, and therefore have larger bonding surface area than existing type tape of same size in which width of an end portion is decreased gradually. Here, the slits have little influence upon the above-described bonding surface area, since slits only divide an end portion of the releasable pressure sensitive adhesive tape in the direction of thickness.

The pulling tab 4 of the releasable pressure sensitive adhesive tape can be formed by providing a region having no adhesive layer in the adhesive tape 1. Alternatively, in an adhesive tape 1 having the adhesive layer provided on the entire surface of the tape, a non-adhesive tab may be provided on an end portion to cover a part of the adhesive layer 3.

Such a non-adhesive tab can be formed of polymer material or paper material, preferably of same material as can be used for the manufacture of the substrate layer.

The releasable pressure sensitive adhesive tape can be formed with the adhesive layer provided not only on one side of the substrate layer but also on both sides thereof depending upon particular applications so as to form a double-coated releasable pressure sensitive adhesive tape. The adhesive layer of this releasable pressure sensitive adhesive tape may be covered with a release liner (not shown) so as to protect the adhesive layer.

### Manufacturing Method of Releasable Adhesive Tape

The releasable pressure sensitive adhesive tape as described above can be manufactured using any known method for the manufacture of pressure sensitive adhesive tape Thus, in the manufacture of a pressure sensitive adhesive tape, an adhesive is coated directly to a substrate layer to form an adhesive layer. Alternatively, an adhesive layer may be formed separately, and then may be laminated on a substrate layer. The substrate layer may be pre-treated prior to the above-mentioned coating or laminating process, using one or more of the following methods, that is, one or more of corona discharge method, plasma discharge method, flame processing method, electron beam irradiation method, UV irradiation method, acid etching method, and chemical primer processing method, so as to improve the adhesion between the substrate layer and the adhesive layer. Such pre-treatment can be performed with or without a reactive chemical adhesion promoter such as hydroxyethyl acrylate or hydroxyethyl methacrylate or other reactive species having a low molecular weight. When a polymer film is used as the substrate layer, pre-treatment using corona discharge is generally preferable.

The releasable adhesive tape obtained as described above, is cut at one end portion using suitable means such as a knife to form slits and to thereby form a divided region for the releasable adhesive tape of the present invention. The adhesive layer may be covered with a release liner as required to protect the adhesive layer until the releasable pressure sensitive adhesive tape is put into use.

### Methods of Using the Releasable Adhesive Tape

This releasable pressure sensitive adhesive tape can be used for various applications. Briefly, the releasable pressure sensitive adhesive tape can be used for mounting applications such as mounting of members such as wall tapestry, side molding of vehicles, pouch, and for indication applications such as road signs, vehicle signs, traffic signs or reflecting sheets, etc. It can also be used for joining applications in which two or more box-shaped containers are adhered to each other and are thereafter separated. It can also be used for sealing applications such as sealing of boxes, containers such as food containers, beverage containers, sealing of diapers, sealing of surgical drapes, etc. It can also be used in removable labels such as price tags, identification labels of containers, or the like. Further, it can also be used for medical applications such as bandages.

This releasable pressure sensitive adhesive tape can be adhered to adherends in various applications as described above in accordance with usual application procedure. In contrast to above-described existing type of same size, this releasable pressure sensitive adhesive tape need not be increased in size in order to assure adequate holding of the adherend. This is because this releasable pressure sensitive adhesive tape has larger bonding surface area as compared to existing types of a similar size, and therefore, can hold the adherend more firmly. As a result, the releasable pressure sensitive adhesive tape is unlikely to be displaced relative to the adherend when subjected to a force (shear stress) along the longitudinal direction. In other words, the distance of displacement of the releasable pressure sensitive adhesive tape in a given time-period as well as the time required for the releasable pressure sensitive adhesive tape to be displaced a definite distance is decreased.

Next, the releasable pressure sensitive adhesive tape is pulled at a low angle relative to the bonding surface, preferably in the direction substantially parallel to the bonding surface, so as to remove same from the adherend. Initial resistance to this type of shear stress is high. If a sufficiently large external force is applied to overcome such resistance, the substrate layer begins to be deformed. When the substrate layer yields to the shear stress, the adhesive layer is stretched and orientated so that it is subjected to hardening in the direction of elongation due to decrease of cross-sectional area. Then, the stress is transferred to the interface due to this hardening effect, giving rise to separation.

In the final stage of removal of the adhesive tape, stress is exerted in the direction perpendicular to the surface of the adherend. In the present invention, as described above, the stress in the final stage of removal can be distributed over several regions (hatched regions). So-called surface peeling that is observed when stress is exerted in the direction perpendicular to the surface of the adherend, can be thereby prevented. In such a case, it becomes difficult for the releasable pressure sensitive adhesive tape to break the adherend during the removal process so that this tape can be easily applied to the surface of fragile material such as a foam type wall paper. Further, the force required in the final stage of removal is also decreased in the present invention. Therefore, an impact at the moment of removal is reduced. Further, when a first adherent and second adherent are bonded by using the adhesive tape, such as used for bonding of a hook to a wall, the danger of the catapult of the adherend (for example, the hook) at the moment of removal can be eliminated.

The adhesive tape of the present invention is advantageously removed by pulling and highly extending at low angle of less than 35°. In such a case, the separation takes place distinctly in the interface between the adhesive layer and the adherend, and no residual adhesive layer is left on the adherend.

On the other hand, when the adhesive tape is pulled at a higher angle, that is, at an angle greater than 35°, the substrate layer is not extended and the adhesive layer is transformed into filaments and is observed to break in solidified form. In such a case, residual adhesive layer may be left on the surface of the adherend or damage to the surface of the adherend may be induced. See the specification of U.S. Pat. No. 3,063,915 for detail of the mechanism of peeling of the releasable adhesive tape.

### EXAMPLES

The present invention will now be described with reference to Examples. It would be easily appreciated by those skilled in the art that the present invention is not limited to these Examples.

### Example

In this Example, “COMMAND™ Tab (Model No. CMR3)”, commercially available from Sumitomo 3M Co., was used. A releasable pressure sensitive adhesive tape of the present Example was fabricated by forming 2 slits of 3 mm in length along the longitudinal direction at equal intervals at the end portion of this adhesive tape opposite the pulling tab.

Removal of this releasable pressure sensitive adhesive tape was then performed as follows.

First, this releasable pressure sensitive adhesive tape was adhered under pressure to an adherend at room temperature (25° C.) to obtain a test sample. An extremely fragile wall paper made of polyvinyl chloride (RH-8315, manufactured by Rumon Co. Ltd) was used as the adherend. A 10 kg roller was used for the press-bonding of the adhesive tape, and was rolled forward and backward only once on the releasable pressure sensitive adhesive tape.

Then, after the test sample was left at room temperature for 1 hour, the pulling tab of the releasable pressure sensitive adhesive tape was pulled at about 5° outward relative to the surface of the adherend at velocity of 500 mm/minute. The releasable pressure sensitive adhesive tape was successfully removed from the adherend without giving rise to breakage of the adherend (that is, transfer of fragment of the adherend to the releasable pressure sensitive adhesive tape).

Also, a retention force test under accelerating conditions was performed on this releasable pressure sensitive adhesive tape in accordance with JIS Z 1524.

First, the releasable pressure sensitive adhesive tape was adhered under pressure to a stainless steel standard plate in accordance with JIS G4305 using a 2 kg roller as described above, and a special hook was attached to the stainless steel standard plate to be used as a test sample.

Then, after this test sample was left at room temperature for 1 hour, a constant static load of 80 kg was applied to the hook at 40° C. Then, after 30 hours, an attempt was made to measure the displacement of the stainless steel standard plate relative to the releasable pressure sensitive adhesive tape. But this displacement was not observed, and the test sample continued to retain the load.

### Comparative Example

In this example, a releasable pressure sensitive adhesive tape was fabricated in the same manner as in the above-described Example, except that above-described end portion of “Command™ Tab” was cut at both sides to provide a sharp taper (taper angle: 53°) with gradually decreasing width toward the end as shown in FIG. 4 so as to decrease bonding surface area by 15%, and slits were not formed.

With the releasable pressure sensitive adhesive tape of this example, the same removal and retention force test were performed as in the above-described Example.

Breakage of the adherend was not observed in the peeling test. In the retention force test, it was observed that the stainless steel standard plate was displaced and completely detached from the releasable pressure sensitive adhesive tape and dropped down together with the load.

What is claimed is:

1. A releasable adhesive tape comprising:
an extensible substrate layer; and
a pressure sensitive adhesive layer coated on at least one surface of said substrate layer;
wherein an end portion of said tape is divided in the longitudinal direction of the tape.

2. A releasable adhesive tape according to claim 1, wherein said end portion is divided by slits.

3. A releasable adhesive tape according to claim 1, wherein said end portion is divided by notches.

4. A releasable adhesive tape according to claim 1, wherein said end portion is provided with slots so as to divide said end portion.

5. A releasable adhesive tape according to claim 1, wherein said end portion is provided with grooves so as to divide said end portion.

6. A releasable adhesive tape according to claim 1, wherein said end portion is provided with a sequence of perforations so as to divide said end portion.
